(19) United States
(12) Patent Application Publication
(10) Pub. No.: US 2018/0051664 A1
(43) Pub. Date: Feb. 22, 2018

(54) METHOD OF MANUFACTURING A FUEL DISTRIBUTOR

(71) Applicant: Benteler Automobiltechnik GmbH, Paderborn (DE)

(72) Inventor: Eugen AUL, Hameln (DE)

(21) Appl. No.: 15/681,767

(22) Filed: Aug. 21, 2017

(30) Foreign Application Priority Data
Aug. 22, 2016 (DE) 10 2016 115 550.0

(51) Int. Cl. F02M 55/00; F02M 55/02; F02M 61/16; F16L 9/04

(52) U.S. Cl. CPC F02M 55/005; F02M 55/02; C21D 7/13; F16L 9/04; F02M 61/168

(57) ABSTRACT

A method of manufacturing a fuel distributor is disclosed. The fuel distributor includes a distributor pipe for receiving pressurized fuel. The distributor pipe has a tubular main body produced from a forged blank processed mechanically. The unprocessed forged blank or the partially processed forged blank is heat treated at a temperature of between 850° C. and 1100° C., in particular of greater than or equal to 950° C., for a period of time of greater than or equal to 60 seconds.

### CROSS REFERENCE TO RELATED APPLICATIONS

The present application claims priority to German Application Number 10 2016 115 550.0 filed Aug. 22, 2016.

### BACKGROUND

### 1. Field of the Invention

The disclosure is related to a fuel distributor and a method of manufacturing thereof. More specifically, the disclosure is related to a method of manufacturing a fuel distributor having a distributor pipe for receiving pressurized fuel, the distributor pipe having a tubular main body produced from a forged blank, and the forged blank being processed mechanically.

### 2. Description of the Related Art

A fuel distributor is a component of a fuel supply system or a fuel injection system and serves to supply fuel to injection valves of an internal combustion engine. Statically compressed fuel is accumulated in a distributor pipe and made available to the injectors or injection valves of a cylinder bank in distributed form. Consequently, as a result of this process, the fuel distributors are exposed to very high pressures.

For example, DE 10 2010 051 004 A1 discloses a fuel distributor in which the distributor pipe is produced by forging. In the case of the fuel distributor known from DE 295 21 402 U1, too, the tubular main body of the distributor pipe is shaped by forging, with connecting branches likewise integrally formed by forging.

Forged main bodies for fuel distributors are forged and cooled in air. Two cooling strategies are common here. A first procedure provides for slow cooling in the air. This cooling leads to relatively little distortion. The second procedure involves rapid cooling in water or oil. This type of cooling entails a relatively high risk of distortion, however.

The noted problems associated with distortion, the procedure which predominates is therefore slow cooling in which the forged blanks are allowed to cool in a controlled manner in air. Then, the forged blanks are blasted. The forging in the air and the slow cooling in the air reduce the corrosion resistance, however. This is caused by the formation of chromium carbides, which can form to an increased extent during the slow cooling. In order to be able to ensure a sufficiently high corrosion resistance, a pickling and passivation process is effected after the mechanical processing of the forged blanks or of the main bodies produced from the forged blanks. This is relatively costly and complex in terms of manufacturing, however. Furthermore, in the region of sealing surfaces, what are termed pickling cavities can lead to an impairment of the sealing surface qualities.

In general, the forged blanks also have residual stresses which arise for manufacturing reasons from the forging process. These have to be taken into account when designing the pipe. Residual stresses of this type can also have a disadvantageous influence on the service lives of the processing tools. Furthermore, the flow lines or grain flows from the forging process influence the accuracy of the mechanical processing, in particular of the deep hole boring for producing the central pressure accumulator channel in the main body.

Proceeding from the prior art, the invention is based on the object of disclosing an efficient and cost-effective method for producing a fuel distributor which is improved in terms of component technology.

### SUMMARY

A method of manufacturing a fuel distributor having a distributor pipe for receiving pressurized fuel, the distributor pipe having a tubular main body made from a forged blank, comprising: mechanically processing the forged blank; and, heat treating the forged blank at a temperature of between 850° C. and 1100° C. for a period of time of greater than or equal to 60 seconds.

### BRIEF DESCRIPTION OF THE DRAWINGS

For an understanding of embodiments of the disclosure, reference is now made to the following description taken in conjunction with the accompanying drawings, in which:

FIG. 1 is a flowchart illustrating one embodiment of method of manufacturing a fuel distributor.

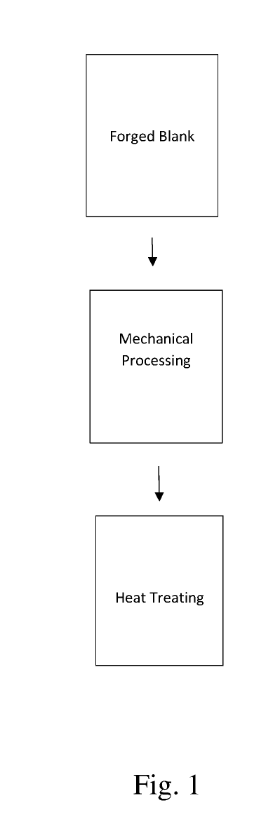

### DETAILED DESCRIPTION OF SOME EMBODIMENTS

The distributor pipe has a tubular, elongate main body. A longitudinal bore in the main body serves as the fuel accumulator. The main body is produced from a forged blank made of a steel material by mechanical processing. The mechanical processing includes essentially cutting processing steps, in particular deep hole boring for producing a continuous bore or a blind bore in the main body and also turning or milling for producing connections.

According to one exemplary embodiment, a tubular main body of the distributor pipe is produced from a forged blank. This is achieved essentially by mechanical processing steps. Mechanical processing steps of this type include cutting shaping methods, in particular the production of a central bore in the main body. This may be a continuous bore or a blind bore. These bores are produced by means of deep hole boring. The mechanical processing steps further include turning or milling of connections and cutting for producing threads.

The manufacturing includes heat treating of the forged blank or of the main body produced from the forged blank. The heat treatment is achieved at a temperature of between 850° C. and 1100° C. for a period of time of greater than or equal to 60 seconds. In particular, the heat treatment is carried out at a temperature of greater than or equal to 950° C. for a period of time of between 60 seconds up to 600 seconds, consequently 10 minutes. The heat treatment is preferably effected over a period of time of 90 seconds, in particular of 120 seconds up to 600 seconds.

The heat treatment can be achieved on the unprocessed forged blank or else on the partially processed forged blank. Furthermore, the main body can also be subjected to the heat treatment after the mechanical processing.

A heat treatment of the unprocessed forged blank before it is mechanically processed is regarded as particularly advantageous.

The parameters of the heat treatment and of the furnace atmosphere which are provided according to the invention lead to a recrystallized material microstructure in the forged blank. The recrystallized material microstructure, with a reduced anisotropic action, has a positive influence on the later further processing. The heat treatment is followed by slow cooling. During the cooling, the temperature is lowered in a uniform and controlled manner under shielding gas. This has the effect that the chromium carbides dissolve again and chromium can bond with oxygen again. This provides for natural repassivation and therefore corrosion resistance. It is also the case that the processing properties of the forged blank for the mechanical processing steps, in particular for the production of a longitudinal bore, are improved.

The heat treatment of preferably above 950° C. leads to dissolution of the chromium carbides. Controlled, uniform cooling prevents the re-formation of chromium carbides and reduces distortion. The heat treatment does away with the need for the previously common pickling and passivation treatment of the main bodies. This leads to a cost saving and moreover entails further manufacturing advantages.

The heat treatment is achieved under a shielding or inert gas atmosphere. In particular, the heat treatment is effected under shielding gas. The shielding gas is composed of a chemically inert component and also an active component. The inert component protects the workpiece. The active component influences the workpiece surface in a targeted manner.

One of the advantage of the disclosure is that the heat treatment is effected under an atmosphere which consists of 70% to 90% hydrogen (H2) and 10% to 30% nitrogen (N2).

A further advantageous atmosphere for the heat treatment consists of 70% to 100% argon (Ar). In the case of a configuration of the method, the heat treatment is effected in an active atmosphere. In this respect, it is provided that the atmosphere in the heat treatment furnace consists at least temporarily of more than 90% hydrogen (H2), in particular of 90% to 100% hydrogen (H2).

Alternatively, it may also be advantageous if the heat treatment is carried out in a fine vacuum at a pressure of between 1 to 10⁻³ mbar (100 Pa to 0.1 Pa) or in a high vacuum at a pressure of between 10⁻³ to 10⁻⁷ mbar (0.1 Pa to 0.00001 Pa).

The heat treatment can be effected in a continuous furnace or a chamber furnace. Steel materials, to be precise austenitic steels, are used with particular preference for producing the forged blanks. Forged blanks made of austenitic chromium-nickel-steel alloys are preferably produced. These have a high corrosion resistance and good processing properties. In particular, it is provided that the forged blanks, and correspondingly the distributor pipes produced therefrom, consist of austenitic steels having the material numbers 1.4301, 1.4306, 1.4307 or 1.4404.

The controlled heat treatment according to the disclosure in an inert or active atmosphere dissolves the chromium carbides produced by slow cooling again. This has the effect that chromium is available for a reaction with oxygen and natural repassivation in a sufficient quantity.

As stated above, the heat treatment according to the disclosure is preferably effected on the unprocessed forged blank before it is mechanically processed. This is particularly advantageous. The residual stresses in the forged blank are reduced, as a result of which it is possible both to improve the component service life and also to increase the service lives of the mechanical processing tools. Furthermore, this leads to a reduction of the flow lines as a consequence of recrystallization processes and therefore to an improvement in the processing properties of the forged blank. It is thereby also possible to achieve a reduction in the distortion during longitudinal boring in the forged blank. As a whole, the corrosion resistance and mechanical properties of the distributor pipe are improved.

The foregoing description of some embodiments of the invention has been presented for purposes of illustration and description. It is not intended to be exhaustive or to limit the invention to the precise form disclosed, and modifications and variations are possible in light of the above teachings or may be acquired from practice of the invention. The specifically described embodiments explain the principles and practical applications to enable one ordinarily skilled in the art to utilize various embodiments and with various modifications as are suited to the particular use contemplated. It is intended that the scope of the invention be defined by the claims appended hereto, and their equivalents. Further, it should be understood that various changes, substitutions and alterations can be made hereto without departing from the spirit and scope of the invention as described by the appended claims.

1. A method of manufacturing a fuel distributor having a distributor pipe for receiving pressurized fuel, the distributor pipe having a tubular main body made from a forged blank, comprising:
mechanically processing the forged blank; and,
heat treating the forged blank at a temperature of between 850° C. and 1100° C. for a period of time of greater than or equal to 60 seconds.

2. The method of claim 1, wherein the heat treatment temperature of between 850° C. and 1100° C. comprises a temperature of greater than or equal to 950° C.

3. The method of claim 1, wherein the heat treatment time of greater than or equal to 60 seconds comprises a period of time between 90 seconds and 10 minutes.

4. The method of claim 1, wherein the heat treatment is carried out in an inert atmosphere.

5. The method of claim 1, wherein the heat treatment is carried out in an active atmosphere.

6. The method of claim 1, wherein the heat treatment is carried out in fine vacuum or in high vacuum.

7. The method of claim 1, wherein the forged blank made of an austenitic steel alloy is used.

8. The method of claim 1, wherein the heat treated forged blank is an unprocessed forged blank.

9. The method of claim 1, wherein the heat treated forged blank is a partially processed forged blank.

10. The method of in claim 1, further comprising heat treating the main body.

11. The method of claim 3, wherein a period of time between 90 seconds and 10 minutes comprises a period of time between 120 seconds and 10 minutes.

12. The method of claim 1, wherein the mechanically processing comprises cutting a central bore in the main body.

13. The method of claim 1, wherein the mechanically processing comprises turning or milling of connections and cutting for producing threads.
